(19) United States
(12) Patent Application Publication
(10) Pub. No.: US 2009/0278027 A1
(43) Pub. Date: Nov. 12, 2009

(54) MOLDING SET FOR CRATING 3-DIMENSIONAL PATTERNS

(76) Inventor: MENG CHIEH LIN, Feng-Yuan City (TW)

Correspondence Address: PHILLIP LIU, 6980, WHITEOAK DRIVE, RICHMOND, V7E4Z9, omitted

(21) Appl. No.: 12/404,301

(22) Filed: Mar. 14, 2009

(30) Foreign Application Priority Data
May 12, 2008 (TW) 097147274

(51) Int. Cl. B29C 33/00

(52) U.S. Cl. 249/160

(57) ABSTRACT

A molding set includes an upper mold and a lower mold. At least one first molding part and at least one second molding part are located on the upper and/or lower mold. The at least one first molding part and at least one second molding part have patterns defined in a surface thereof, and the at least one first molding part and at least one second molding part have different coefficients of heat isolation. By the different coefficients of heat isolation, the foam products include 3-dimentional patterns formed thereon and the 3-dimentional patterns have different levels of density change.

### FIELD OF THE INVENTION

The present invention relates to a molding set for crating 3-dimensional patterns on foam products.

### BACKGROUND OF THE INVENTION

A conventional foam product such as the foam pads made of Ethylene Vinyl Acetate is used in wide range of everyday living of our life. However, due to boring color, such conventional foam pads cannot be satisfied by the users. Therefore, the latest foam products include pre-set patterns which are 3-dimensional patterns.

The conventional way to create the 3-dimensional patterns on the foam products is to use an upper mold on a pressing unit and a lower mold on the work platform. Both of the upper and lower molds are made of metal and either of the two molds is craved with patterns. Foaming material is injected in the space between the upper and lower molds, and the foaming material is then pressed at a pre-set temperature to foam the foaming material with the 3-dimensional patterns.

There are several drawbacks for the conventional way, the first is that the patterns craved in the mold can not be changed so that the patterns are fixed, which makes the products to be boring. The second drawback is that the craving in the mold is a time consuming task and very expensive. The third drawback is that the metal that makes the mold has a fixed and single heat isolation coefficient which cannot create the patterns with any level of density change. This reduces the visual result of the 3-dimentional patterns. The fourth drawback is that the foaming material is difficult to control its shape and size after being pressed and heated. The 3-dimensional patterns can be easily deformed or become flat.

The present invention intends to provide a molding set for creating 3-dimensional patterns on foam products and the patterns include different levels of density change.

### SUMMARY OF THE INVENTION

The present invention relates to a molding set for creating 3-dimensional patterns on foam produces, and the molding set includes an upper mold and a lower mold. At least one first molding part and at least one second molding part are located on the upper and/or lower mold. The at least one first molding part and at least one second molding part have patterns defined in a surface thereof, and the at least one first molding part and at least one second molding part have different coefficients of heat isolation.

The foam products made by the molding set include 3-dimentional patterns formed thereon and the 3-dimentional patterns have different levels of density change.

The primary object of the present invention is to provide a molding set for creating 3-dimensional patterns with different levels of density for single color foaming material.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the foam product made by the molding set of the present invention;

FIG. 2 is a partial cross sectional view to show the molding parts one the upper mold and the lower mold of the molding set of the present invention;

FIG. 3 is a partial cross sectional view to show that the molding set of the present invention includes the molding parts on the upper mold only;

FIG. 4 is a partial cross sectional view to show that the molding set of the present invention includes the molding parts on the lower mold only;

FIG. 5 shows that isolation chips or plates are connected on the molding parts of the molding set of the present invention, and

FIG. 6 is a perspective view to show the molding parts of the present invention.

### DETAILED DESCRIPTION OF THE PREFERRED EMBODIMENT

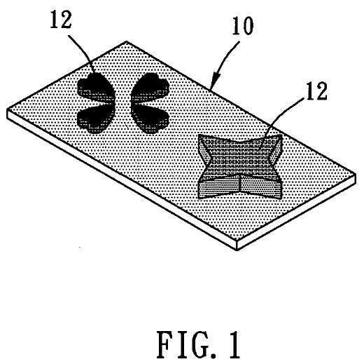

Referring to FIG. 1, the foam product 10 made by the molding set of the present invention is shown and includes convex 3-dimentional patterns formed thereon. The foam product can be made by Ethylene Vinyl Acetate, Thermo-plastic elastomers, polyurethane, polyvinyl chloride or Thermo-plastic rubber. After the foam product 10 is foamed, the foam product 10 is then put into the molding set of the present invention and the 3-dimensional patterns 12 are made on one or two surfaces thereof. The 3-dimensional patterns 12 can be convex or concave patterns.

The 3-dimensional patterns 12 are made by first and second molding parts “A” and “B”, and the first and second molding parts “A” and “B” are made of metallic material or non-metallic material with different coefficients heat isolation. By the feature of the different coefficients heat isolation, the 3-dimensional patterns 12 have different levels of density of color.

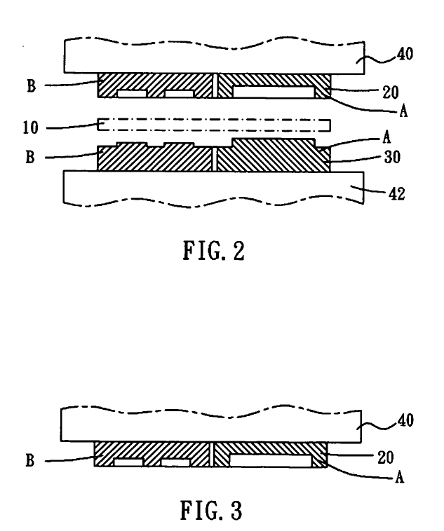

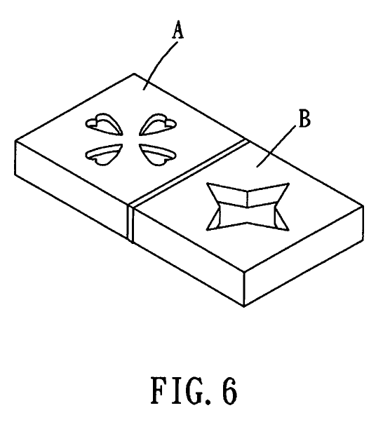

Referring to FIGS. 2 and 6, molding set comprises an upper mold 20 and a lower mold 30, the upper mold 20 is connected to the pressing unit 40 and the lower mold 30 is connected to the work platform 30. The foam product 10 is put between the upper mold 20 and the lower mold 30.

There are one first molding part “A” and one second molding part “B” connected to the upper and lower molds 20, 30 respectively. The number of the first molding part “A” and the second molding part “B” can be vary according to practical needs. The first molding part “A” and the second molding part “B” have patterns defined in a surface thereof. The first molding part “A” and the second molding part “B” on each of the upper and lower molds 20, 30 can be arranged in any way such as snapped to each other, overlapped each other, or combined to form a specific form. The first molding parts “A” and the second molding parts “B” have different coefficients of heat isolation.

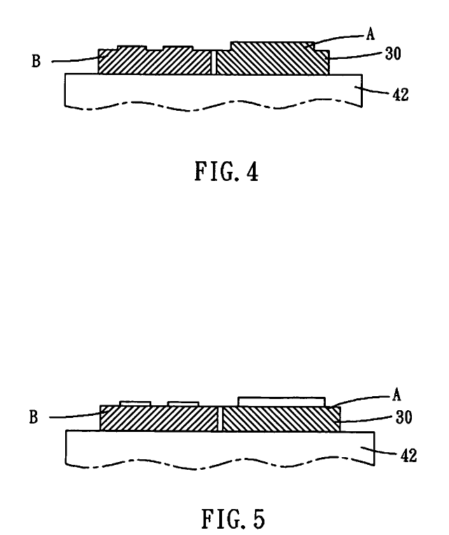

It is noted that the first molding part “A” and the second molding part “B” can only be connected to the upper mold 20 or the lower mold 30 as shown in FIGS. 3 and 4. By this arrangement, the foam product 10 has the patterns on one surface to which the first molding part “A” and the second molding part “B” are pressed.

The first molding part “A” and the second molding part “B” are both made by metallic material with different coefficients of heat isolation. The first molding part “A” and the second molding part “B” can be made by non-metallic material with different coefficients of heat isolation. Of course, the first molding part “A” and the second molding part “B” can be made by combination of metallic material and non-metallic material with different coefficients of heat isolation. The non-metallic material is made of silicone film, Polytetrafluoro ethylene, plastic film, netted fabric with ink printed thereon or bakelite chip.

The first molding part “A” and the second molding part “B” may include multiple layers and each layer may have different coefficients of heat isolation. The multiple layers can also be arranged to include the metallic layer and/or non-metallic layer alternatively overlapped.

The metal, fabric, non-woven fabric, netted fabric or other material can be used as the base portion and coating material of different coefficients of heat isolation is coated on the base portion. The coating material can be coated by way of spreading, printing, transfer printing, adhering or any known method.

By controlling the pressing pressure, the temperature and the pressing time, the patterns of the first molding part “A” and the second molding part “B” can create a desired patterns. The different portions that are in contact with the first molding part “A” and the second molding part “B” having different coefficients of heat isolation will have different levels of shrinking. The more that the areas of the foam product 10 shrink, the darker of the color of the patterns and the deeper of the patterns will be.

It is noted that the netted fabric includes longitude and latitude lines to define multiple square spaces and the longitude and latitude lines are coated with the ink of the same coefficient of heat isolation or different coefficient of heat isolation. When multiple netted fabrics are overlapped to each other, the foam product 10 will have multiple hollow rectangular and/or square patterns and the lines will have different depths if the ink on the lines has different coefficient of heat isolation.

As shown in FIG. 5, the first molding part “A” and the second molding part “B” may simply have heat isolation chips or plates connected thereon and the heat isolation chips or plates may have the same or different coefficient of heat isolation so that the foam product 10 will have deep and shallow patterns thereon.

The molding set is used to create patterns 12 to the foam products 10 which have been foamed so that the products 10 do not shrink too much so that the final quality of the foam products can be controlled. The number of the first molding part “A” and the second molding part “B” can be decided as needed to create the patterns 12 such that the craving expense can be saved. By using the first molding part “A” and the second molding part “B” of different coefficient of heat isolation, the foam products 10 can have various levels of density change. The density change makes the single color foam product 10 to be vivid and attractive.

While we have shown and described the embodiment in accordance with the present invention, it should be clear to those skilled in the art that further embodiments may be made without departing from the scope of the present invention.

What is claimed is:

1. A molding set comprising:
at least one first molding part and at least one second molding part, the at least one first molding part and at least one second molding part having patterns defined in a surface thereof, the at least one first molding part and at least one second molding part having different coefficients of heat isolation.

2. The molding set as claimed in claim 1, wherein the molding set includes an upper mold and a lower mold.

3. The molding set as claimed in claim 1, wherein the molding set is one of an upper mold and a lower mold.

4. The molding set as claimed in claim 1, wherein the at least one first molding part and at least one second molding part are made by metallic material with different coefficients of heat isolation.

5. The molding set as claimed in claim 1, wherein the at least one first molding part and at least one second molding part are made by non-metallic material with different coefficients of heat isolation.

6. The molding set as claimed in claim 1, wherein the at least one first molding part and at least one second molding part are made by combination of metallic material and non-metallic material with different coefficients of heat isolation.

7. The molding set as claimed in claim 5, wherein the non-metallic material is made of silicone film, Polytetrafluoro ethylene, plastic film, netted fabric with ink printed thereon or bakelite chip.

8. The molding set as claimed in claim 6, wherein the non-metallic material is made of silicone film, Polytetrafluoro ethylene, plastic film, netted fabric with ink printed thereon or bakelite chip.

9. The molding set as claimed in claim 1, the at least one first molding part and at least one second molding part include multiple layers.

10. The molding set as claimed in claim 9, the multiple layers of one of the at least one first molding part and the at least one second molding part is made of metallic material with different coefficients of heat isolation.

11. The molding set as claimed in claim 9, the multiple layers of one of the at least one first molding part and the at least one second molding part is made of non-metallic material with different coefficients of heat isolation.

12. The molding set as claimed in claim 9, the multiple layers of the at least one first molding part and the at least one second molding part are made of metallic material and non-metallic material.
